(19) United States
(12) Patent Application Publication
(10) Pub. No.: US 2025/0056342 A1
(43) Pub. Date: Feb. 13, 2025

(54) METHOD AND APPARATUS FOR RACH-LESS HANDOVER

(71) Applicant: Electronics and Telecommunications Research Institute, Daejeon (KR)

(72) Inventors: You Sun HWANG, Daejeon (KR); Sung Min OH, Daejeon (KR)

(21) Appl. No.: 18/798,742

(22) Filed: Aug. 8, 2024

(30) Foreign Application Priority Data
Aug. 9, 2023 (KR) 10-2023-0104261
Jul. 12, 2024 (KR) 10-2024-0092481

(51) Int. Cl. H04W 36/00; H04W 36/30; H04W 72/21

(52) U.S. Cl. CPC H04W 36/00725; H04W 36/0079; H04W 36/302; H04W 72/21

(57) ABSTRACT

A method of a terminal for a RACH-less handover may comprise: receiving, from a source cell, information on a UL grant for UL transmission in a target cell, the information on the UL grant including a start time and an expiration time of the UL grant and/or a maximum number of transmissions according to the UL grant; performing transmission of an RRC reconfiguration complete message using resources indicated by the UL grant from the start time, until the expiration time or until the transmission is completed up to the maximum number of transmissions from the start time; and in response to the transmission of the RRC reconfiguration complete message not being successful until the expiration time or until the transmission is completed up to the maximum number of transmissions, performing a fallback procedure for the RACH-less handover.

### CROSS-REFERENCE TO RELATED APPLICATIONS

This application claims priority to Korean Patent Applications No. 10-2023-0104261, filed on Aug. 9, 2023, and No. 10-2024-0092481, filed on Jul. 12, 2024, with the Korean Intellectual Property Office (KIPO), the entire contents of which are hereby incorporated by reference.

### BACKGROUND

### 1. Technical Field

The present disclosure relates to a random access channel (RACH)-less handover procedure in a mobile communication system, and more particularly, to a method and an apparatus for quickly recovering a RACH-less handover failure when the RACH-less handover failure occurs.

### 2. Related Art

In a typical communication system, handover techniques are used to ensure smooth communication for a terminal moving between cells. A base station (e.g. gNodeB) can manage services and mobility for the terminal through a radio resource control (RRC) connection with the terminal.

Discussions have been ongoing on reducing a handover interruption time, which occurs from a time when the terminal receives a handover command from a serving base station (or source base station) and disconnects from it, until a time when the handover procedure with a target base station is completed. For example, the terminal may be unable to transmit or receive data during the handover interruption time that occurs from the time when the terminal disconnects a radio connection with the serving base station until a time when a random access channel (RACH) procedure to the target base station is successfully completed and the terminal first receives downlink data from the target base station. Therefore, to minimize the handover interruption time during which the terminal is unable to transmit or receive data, a handover without the RACH procedure (RACH-less Handover) is being discussed.

The RACH-less handover may be allowed when the serving base station and the target base station use the same timing or when the terminal can know timing information of the target base station in advance. In the case of performing the RACH-less handover, the serving base station provides the terminal with pre-configured uplink (UL) grant or dynamic UL grant information for the target base station, and the terminal can use the UL grant information to determine a transmission timing to the target base station.

The pre-configured UL grant scheme may use a configured grant (CG) Type 1 scheme. That is, a configured grant may be configured through RRC signaling to allocate periodic resources to the terminal, and the terminal may transmit data using the configured grant resource. The dynamic UL grant scheme may be a scheme of allocating a physical downlink control channel (PDCCH) resource to the terminal. That is, the terminal may transmit data using a resource scheduled by downlink control information (DCI) received in the PDCCH resource.

Due to the advantage of minimizing the aforementioned handover interruption time, the RACH-less handover method has been proposed to the 3rd Generation Partnership Project (3GPP) and is being standardized. However, a method for detecting a failure of the RACH-less handover and an operation method for the terminal when a failure occurs during the process of performing the RACH-less handover to the target base station have not yet been specifically determined.

### SUMMARY

The present disclosure for resolving the above-described problems is directed to providing an operation method of a terminal for performing a RACH-less handover in a mobile communication system.

The present disclosure for resolving the above-described problems is also directed to providing an operation method of a source base station for performing a RACH-less handover in a mobile communication system.

The present disclosure for resolving the above-described problems is also directed to providing an operation method of a target base station for performing a RACH-less handover in a mobile communication system.

A method of a terminal, according to an exemplary embodiment of the present disclosure, may comprise: receiving, from a source cell, information on an uplink (UL) grant for UL transmission in a target cell, the information on the UL grant including a start time and an expiration time of the UL grant and/or a maximum number of transmissions according to the UL grant; performing transmission of a radio resource configuration (RRC) reconfiguration complete message using resources indicated by the UL grant from the start time, until the expiration time or until the transmission is completed up to the maximum number of transmissions from the start time; and in response to the transmission of the RRC reconfiguration complete message not being successful until the expiration time or until the transmission is completed up to the maximum number of transmissions, performing a fallback procedure for the RACH-less handover.

The UL grant may be a pre-configured UL grant or dynamic UL grant.

The start time of the UL grant may be indicated by a system frame number (SFN) and a subframe number.

The expiration time of the UL grant may be indicated by a setting value for a timer that starts at the start time of the UL grant.

The information on the UL grant may be transmitted from a target base station operating the target cell to a source base station operating the source cell through a handover request acknowledge message, and may be received from the source base station through an RRC reconfiguration message.

The fallback procedure for the RACH-less handover may comprise: measuring received signal strengths of the source cell and the target cell; in response to the received signal strength of the target cell being better than the received signal strength of the source cell, performing a RACH procedure to the target cell; and transmitting the RRC reconfiguration complete message to the target cell after performing the RACH procedure.

The information on the UL grant may additionally include information on a dedicated RACH preamble to be used in the target cell, and the RACH procedure may be a contention-free random access (CFRA) procedure using the dedicated RACH preamble.

The fallback procedure for the RACH-less handover may further comprise: in response to the received signal strength of the source cell being better than the received signal strength of the target cell, performing an RRC connection re-establishment procedure for the source cell.

A method of a source base station, according to an exemplary embodiment of the present disclosure, may comprise: deciding a handover of a terminal based on a measurement report received from the terminal; transmitting a handover request message requesting the decided handover to a target base station of a target cell determined based on the measurement report received from the terminal; receiving, from the target base station, information on an uplink (UL) grant for uplink transmission in the target cell, the information on the UL grant including a start time and an expiration time of the UL grant and/or a maximum number of transmissions according to the UL grant; transmitting the information on the UL grant to the terminal; attempting reception of a radio resource control (RRC) reconfiguration complete message from the terminal using resources indicated by the UL grant; and in response to the reception of the RRC reconfiguration complete message not being successful until the expiration time or until transmission of the RRC reconfiguration complete message is completed up to the maximum number of transmissions, performing a fallback procedure for the RACH-less handover with the terminal.

The start time of the UL grant may be indicated by a system frame number (SFN) and a subframe number.

The expiration time of the UL grant may be indicated by a setting value for a timer that starts at the start time of the UL grant.

The UL grant may be a pre-configured UL grant or dynamic UL grant.

The information on the UL grant may be transmitted from the target base station to the source base station through a handover request acknowledge message, and may be transmitted to the terminal through an RRC reconfiguration message.

The fallback procedure for the RACH-less handover may comprise: in response to the received signal strength of a source cell of the source base station being better than the received signal strength of the target cell, performing an RRC connection re-establishment procedure with the terminal.

A method of a target base station, according to an exemplary embodiment of the present disclosure, may comprise: receiving a handover request message requesting a handover for a terminal from a source base station of a source cell; transmitting, to the source base station, information on an uplink (UL) grant for uplink transmission in a target cell of the target base station, the information on the UL grant including a start time and an expiration time of the UL grant and/or a maximum number of transmissions according to the UL grant; attempting reception of a radio resource control (RRC) reconfiguration complete message from the terminal using resources indicated by the UL grant; and in response to the reception of the RRC reconfiguration complete message not being successful until the expiration time or until transmission of the RRC reconfiguration complete message is completed up to the maximum number of transmissions, performing a fallback procedure for the RACH-less handover with the terminal.

The start time of the UL grant may be indicated by a system frame number (SFN) and a subframe number.

The expiration time of the UL grant may be indicated by a setting value for a timer that starts at the start time of the UL grant.

The information on the UL grant may be transmitted from the target base station to the source base station through a handover request acknowledge message, and is transmitted from the source base station to the terminal through an RRC reconfiguration message.

The fallback procedure for the RACH-less handover may comprise: in response to the received signal strength of the target cell being better than the received signal strength of the source cell, performing a RACH procedure with the terminal; and receiving the RRC reconfiguration complete message from the terminal after performing the RACH procedure.

The information on the UL grant may additionally include information on a dedicated RACH preamble to be used in the target cell, and the RACH procedure may be a contention-free random access (CFRA) procedure using the dedicated RACH preamble.

According to the exemplary embodiments of the present disclosure, a start time and an expiration time of a UL grant resource for a RACH-less handover can be configured, and the maximum number of UL message transmissions using the UL grant resource can be specified. Based on the expiration time of the UL grant resource and the maximum number of UL message transmissions, the terminal can quickly determine a failure of the RACH-less handover and promptly recover or fallback from it, thereby reducing a handover interruption time. Moreover, by swiftly detecting the failure of the RACH-less handover, the terminal can quickly release UL grant resources allocated in advance for candidate target cells, enhancing overall resource efficiency of the communication system.

### BRIEF DESCRIPTION OF DRAWINGS

FIG. 1 is a conceptual diagram illustrating a first exemplary embodiment of a communication system.

FIG. 2 is a block diagram illustrating a first exemplary embodiment of a communication node constituting a communication system.

FIG. 3 is a sequence chart of an exemplary embodiment of a handover procedure in the 3GPP mobile communication system.

FIG. 4 is a sequence chart of another exemplary embodiment of a handover procedure in the 3GPP mobile communication system.

FIG. 5 is a sequence chart for describing a RACH-less handover procedure according to an exemplary embodiment of the present disclosure.

FIG. 6 is a sequence chart for describing a RACH-less handover procedure according to another exemplary embodiment of the present disclosure.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e. “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication system to which exemplary embodiments according to the present disclosure are applied will be described. The communication system may be the 4G communication system (e.g. Long-Term Evolution (LTE) communication system or LTE-A communication system), the 5G communication system (e.g. New Radio (NR) communication system), the sixth generation (6G) communication system, or the like. The 4G communication system may support communications in a frequency band of 6 GHz or below, and the 5G communication system may support communications in a frequency band of 6 GHz or above as well as the frequency band of 6 GHz or below. The communication system to which the exemplary embodiments according to the present disclosure are applied is not limited to the contents described below, and the exemplary embodiments according to the present disclosure may be applied to various communication systems. Here, the communication system may be used in the same sense as a communication network, ‘LTE’ may refer to ‘4G communication system’, ‘LTE communication system’, or ‘LTE-A communication system’, and ‘NR’ may refer to ‘5G communication system’ or ‘NR communication system’.

In exemplary embodiments, ‘configuration of an operation (e.g. transmission operation)’ may mean ‘signaling of configuration information (e.g. information element(s), parameter(s)) for the operation’ and/or ‘signaling of information indicating performing of the operation’. ‘Configuration of information element(s) (e.g. parameter(s))’ may mean that the corresponding information element(s) are signaled. ‘Configuration of a resource (e.g. resource region)’ may mean that configuration information of the corresponding resource is signaled. The signaling may be performed based on at least one of system information (SI) signaling (e.g. transmission of system information block (SIB) and/or master information block (MIB)), RRC signaling (e.g. transmission of RRC parameters and/or higher layer parameters), MAC control element (CE) signaling, PHY signaling (e.g. transmission of downlink control information (DCI), uplink control information (UCI), and/or sidelink control information (SCI)), or a combination thereof.

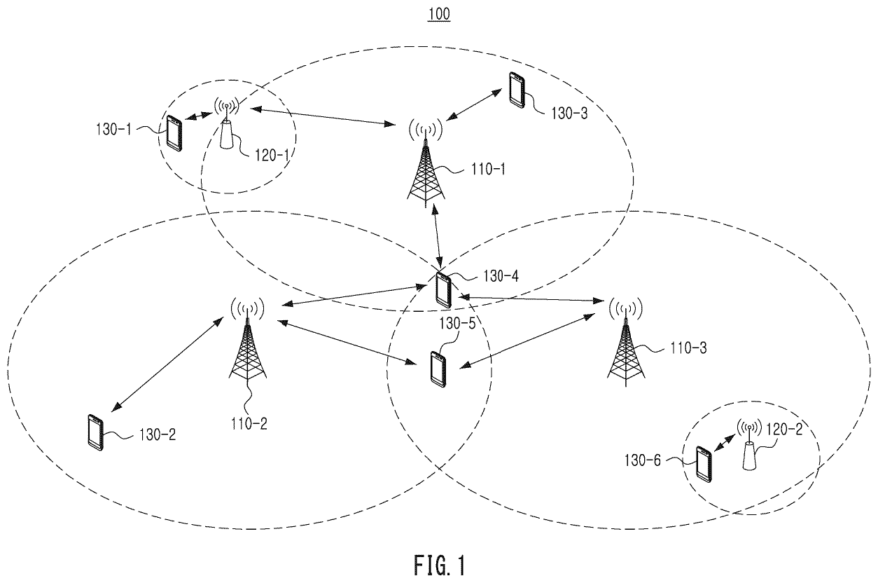

FIG. 1 is a conceptual diagram illustrating a first exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Also, the communication system 100 may further comprise a core network (e.g. a serving gateway (S-GW), a packet data network (PDN) gateway (P-GW), and a mobility management entity (MME)). When the communication system 100 is a 5G communication system (e.g. New Radio (NR) system), the core network may include an access and mobility management function (AMF), a user plane function (UPF), a session management function (SMF), and the like.

The plurality of communication nodes 110 to 130 may support communication protocols defined in the 3rd generation partnership project (3GPP) technical specifications (e.g. LTE communication protocol, LTE-A communication protocol, NR communication protocol, or the like). The plurality of communication nodes 110 to 130 may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform-spread-OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter band multi-carrier (FBMC) based communication protocol, universal filtered multi-carrier (UFMC) based communication protocol, space division multiple access (SDMA) based communication protocol, or the like. Each of the plurality of communication nodes may mean an apparatus or a device. Exemplary embodiments may be performed by an apparatus or device. A structure of the apparatus (or, device) may be as follows.

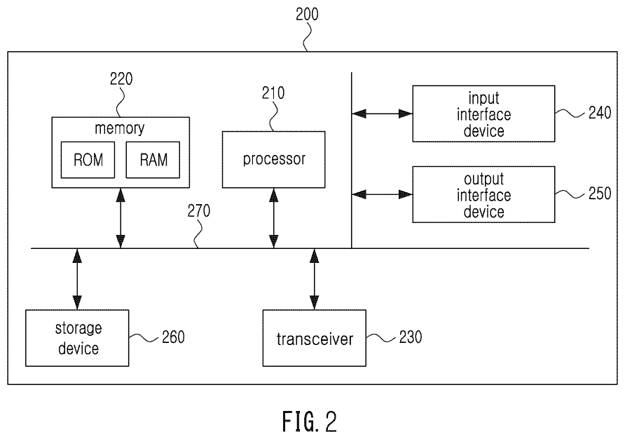

FIG. 2 is a block diagram illustrating a first exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. The respective components included in the communication node 200 may communicate with each other as connected through a bus 270.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to the cell coverage of the first base station 110-1. Also, the second terminal 130-2, the fourth terminal 130-4, and the fifth terminal 130-5 may belong to the cell coverage of the second base station 110-2. Also, the fifth base station 120-2, the fourth terminal 130-4, the fifth terminal 130-5, and the sixth terminal 130-6 may belong to the cell coverage of the third base station 110-3. Also, the first terminal 130-1 may belong to the cell coverage of the fourth base station 120-1, and the sixth terminal 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), gNB, advanced base station (ABS), high reliability-base station (HR-BS), base transceiver station (BTS), radio base station, radio transceiver, access point (AP), access node, radio access station (RAS), mobile multi-hop relay-base station (MMR-BS), relay station (RS), advanced relay station (ARS), high reliability-relay station (HR-RS), home NodeB (HNB), home eNodeB (HeNB), road side unit (RSU), radio remote head (RRH), transmission point (TP), transmission and reception point (TRP), or the like.

Each of the plurality of terminals 130-1, 130-2, 130-3, 130-4, 130-5, and 130-6 may be referred to as user equipment (UE), terminal equipment (TE), advanced mobile station (AMS), high reliability-mobile station (HR-MS), terminal, access terminal, mobile terminal, station, subscriber station, mobile station, portable subscriber station, node, device, on-board unit (OBU), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support a multi-input multi-output (MIMO) transmission (e.g. single-user MIMO (SU-MIMO), multi-user MIMO (MU-MIMO), massive MIMO, or the like), a coordinated multipoint (CoMP) transmission, a carrier aggregation (CA) transmission, a transmission in unlicensed band, a device-to-device (D2D) communication (or, proximity services (ProSe)), an Internet of Things (IoT) communication, a dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e. the operations supported by the plurality of base stations 110-1, 110-2, 110-3, 120-1, and 120-2). For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

Each of the first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the COMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, to facilitate understanding of exemplary embodiments of the present disclosure, a conventional handover procedure of the 3GPP mobile communication system will be roughly described. Hereinafter, only parts related to exemplary embodiments of the present disclosure will be described in the overall handover procedure to the extent that the gist of the exemplary embodiments of the present disclosure is not obscured.

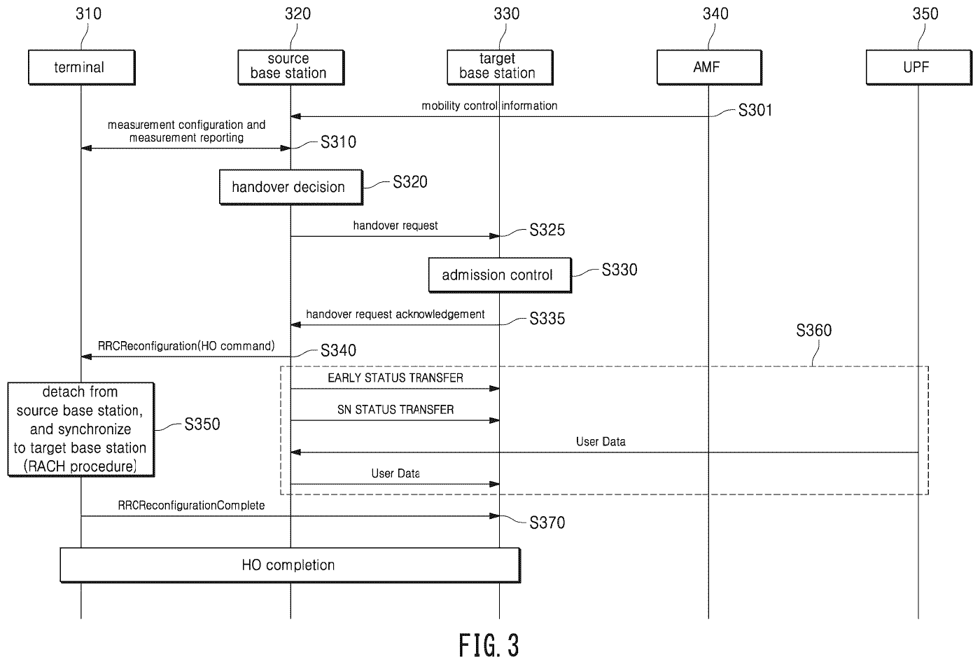

FIG. 3 is a sequence chart of an exemplary embodiment of a handover procedure in the 3GPP mobile communication system.

Referring to FIG. 3, a general intra-AMF/UPF handover procedure in the 3GPP mobile communication system is illustrated. In FIG. 3, a terminal 310, a source base station 320 operating a current serving cell (i.e. source cell), a target base station 330 operating a target cell, and an AMF 340 and UPF 350 constituting a core network are disclosed. Hereinafter, the source base station and the target base station may be referred to as a source cell and a target cell, respectively. Alternatively, the source cell and the target cell may be referred to as the source base station and the target base station that operate the respective cells.

The AMF 340 included in the core network previously described in FIG. 1 may provide mobility control information to the source base station 320 (S301).

The terminal 310 that receives measurement configuration information from the source base station 320 may perform measurements according to the measurement configuration information, and transmit measurement results to the source base station 320 through a measurement report (S310).

According to the measurement report received from the terminal 310, the source base station 320 may decide a handover for the terminal 310 (S320).

When the handover for the terminal 310 is decided, the source base station 320 may transmit a handover request message to the target base station 330 (S325). In response to the handover request message, the target base station 330 may perform admission control for the requested handover (S330). When the target base station 330 approves the requested handover, the target base station 330 may transmit a handover request acknowledge message to the source base station 320 (S335).

The source base station 320, which receives the handover request acknowledge message from the target base station 330, may transmit a handover command to the terminal 310 (S340). The handover command may be transmitted through an RRC reconfiguration (i.e. RRCReconfiguration) message.

The terminal 310 that receives the handover command may detach from the existing connection with the source base station 320, and perform a synchronization procedure (i.e. RACH procedure) for synchronization with the target base station 330 (S350).

Meanwhile, the source base station 320 may deliver buffered data for the terminal to the target base station 330, and perform a procedure for forwarding new data for the terminal transmitted from the UPF 350 to the target base station 330 (S360).

When synchronization with the target base station 330 is acquired, the terminal 310 may transmit an RRC reconfiguration complete (i.e. RRCReconfigurationComplete) message to the target base station 330.

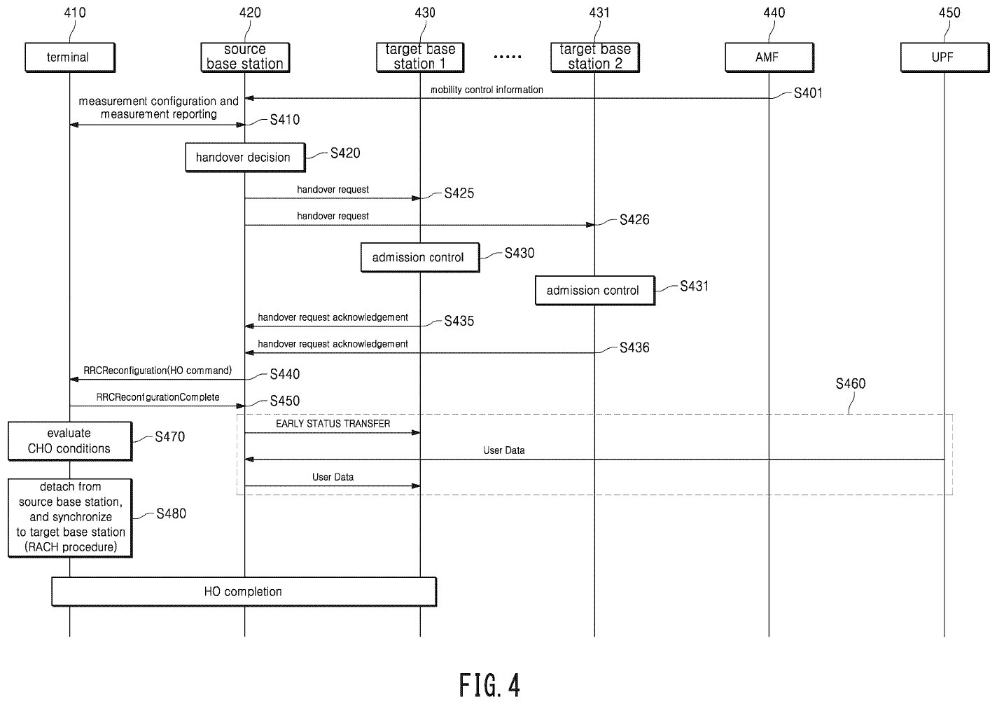

FIG. 4 is a sequence chart of another exemplary embodiment of a handover procedure in the 3GPP mobile communication system.

Referring to FIG. 4, a conditional intra-AMF/UPF handover procedure in the 3GPP mobile communication system is illustrated. In FIG. 4, a terminal 410, a source base station 420 operating a current serving cell (i.e. source cell), candidate target base stations 430 and 431 operating candidate target cells, and an AMF 440 and UPF 440 constituting a core network are illustrated. Hereinafter, the source base station and the candidate target base station may be referred to as a source cell and a candidate target cell, respectively. Alternatively, the source cell and the candidate target cell may be referred to as the source base station and the candidate target base station that operate the respective cells. Meanwhile, comparing the procedure illustrated in FIG. 3 with the procedure illustrated in FIG. 4, a difference in the procedure illustrated in FIG. 4 may be that a plurality of target candidate cells can participate in the handover procedure. That is, in a conditional handover, a handover request message may be transmitted from the source base station to each candidate target cell that can become a target cell.

Similarly to the general handover procedure illustrated in FIG. 3, the AMF 440 included in the core network previously described in FIG. 1 may provide mobility control information to the source base station 420 (S401).

The terminal 410 that receives measurement configuration information from the source base station 420 may perform measurements according to the provided measurement configuration information, and transmit measurement results to the source base station 420 through a measurement report (S410).

According to the measurement report received from the terminal 410, the source base station 420 may decide a conditional handover for the terminal 420 (S420).

Unlike the general handover procedure described in FIG. 3, in the conditional handover procedure described in FIG. 4, the source base station may transmit handover request messages to one or more candidate target base stations 430 and 431 that meet handover event conditions (S425, S426). Although FIG. 4 illustrates a case in which two candidate target base stations 430 and 431 exist, the number of candidate target base stations may not be limited to two.

In response to the handover request message from the source base station 420, each of the candidate target base stations 430 and 431 may perform admission control for the requested handover (S430, S431). Each candidate target base station that approves the requested handover may transmit a handover request acknowledge message to the source base station (S435, S436).

If at least one candidate target base station approves the requested handover, the source base station 420 may transmit a handover command to the terminal (S440). The handover command may be transmitted through an RRC reconfiguration (i.e. RRCReconfiguration) message.

The terminal 410 may transmit an RRC reconfiguration complete (i.e. RRCReconfigurationComplete) message to the source base station 420 in response to the RRC reconfiguration message (S450). In the general handover procedure, the RRC reconfiguration complete message is transmitted to the target base station after the synchronization procedure (RACH procedure) with the target base station is completed, but in the conditional handover procedure, the RRC reconfiguration complete message may be transmitted from the terminal 410 to the source base station 420.

Afterwards, the terminal may evaluate whether at least one candidate target base station meets conditional handover conditions (CHO conditions) (S470). If a target base station (e.g. target base station 430 in FIG. 4) that meets the CHO conditions exists, the terminal may disconnect the existing connection with the source base station 420, and perform a synchronization procedure (i.e. RACH procedure) for synchronization with the target base station 430 (S480).

Meanwhile, the source base station 420 may deliver buffered data for the terminal to the target base station 430, and perform a procedure for forwarding new data for the terminal 410 transmitted from the UPF 450 to the target base station 430 (S460).

### Fallback Method in RACH-Less Handover Procedure

Meanwhile, the RACH-less handover is a handover procedure in which the synchronization procedure (i.e. RACH procedure) for the target cell is omitted, unlike the conventional handover procedures described with reference to FIGS. 3 and 4 above. In the RACH-less handover, information on a UL resource (i.e. UL-grant resource) for first UL transmission to be performed by the terminal in the target cell may be provided in advance to the terminal from the target cell via the source cell. That is, when the RACH-less handover is performed, a UL grant for the UL resource (i.e. UL-grant resource) of the target base station may be provided to the terminal in a pre-configured UL-grant scheme or a dynamic UL-grant scheme. For example, the terminal may transmit the RRCReconfigurationComplete message using the allocated UL-grant resource of the target base station.

The present disclosure proposes a method to quickly detect a failure of the RACH-less handover procedure and perform a fallback procedure.

Specifically, when configuring a UL-grant resource for first uplink transmission in the target cell to the terminal using the pre-configured UL-grant scheme or the dynamic UL-grant scheme, a start time and an expiration time of the UL-grant and/or the maximum number of transmissions of a UL message (e.g. RRCReconfigurationComplete message) may be additionally set to the terminal. Using these, the terminal can quickly determine a time when recovery or fallback for the RACH-less handover is required. In addition, by being able to quickly determine the time when recovery or fallback for the RACH-less handover is required, it is made possible to quickly release UL-grant resource(s) reserved in the candidate target cell(s). Therefore, efficient use of resources becomes possible.

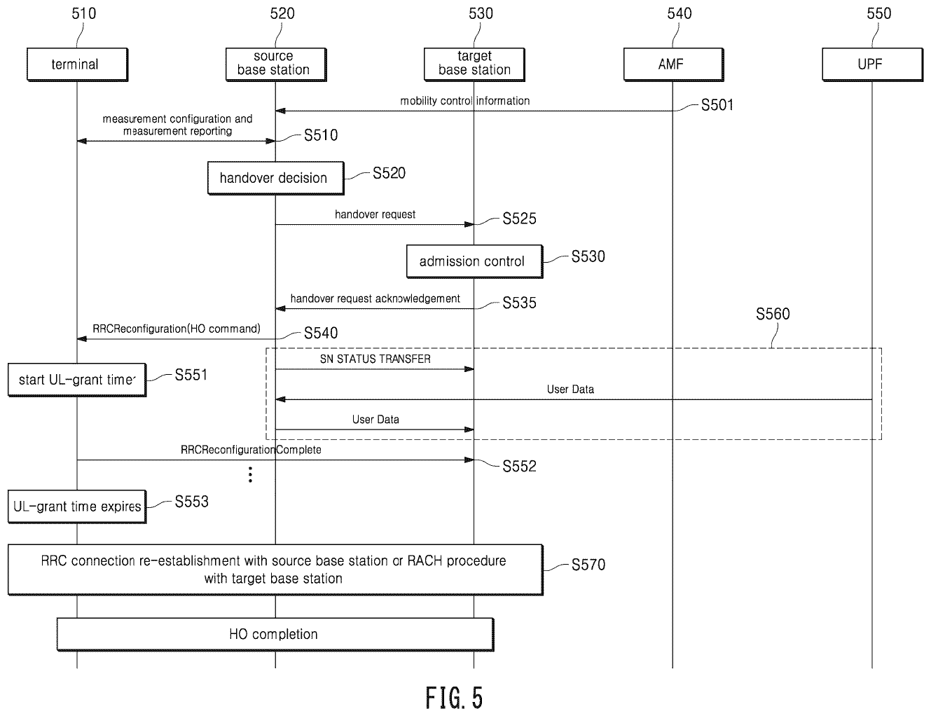

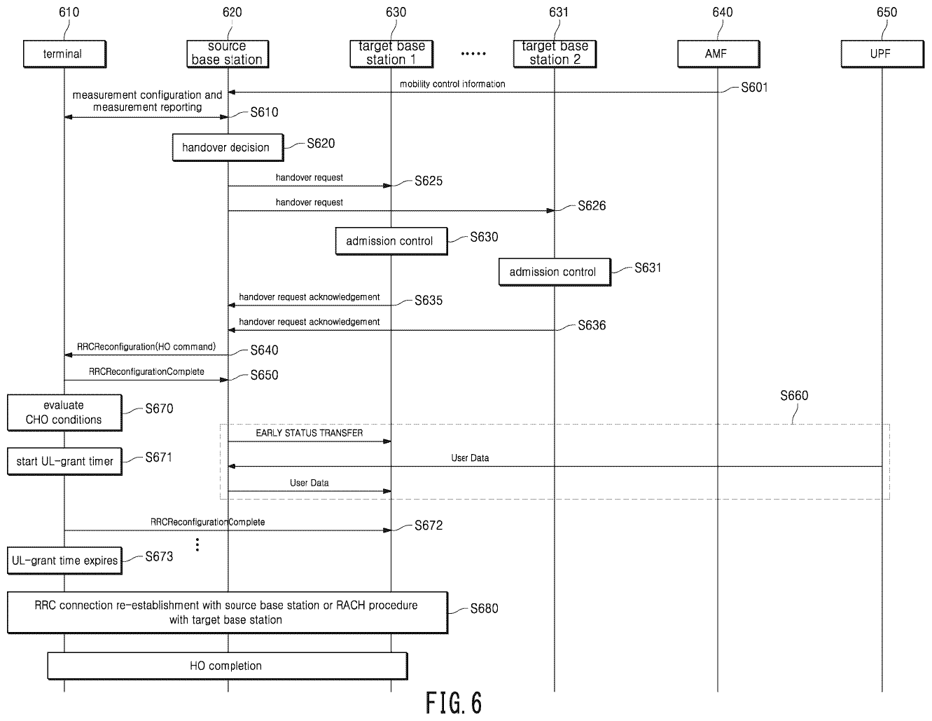

The fallback method for RACH-less handover described below may be used in both general handover procedures and conditional handover procedures. In FIG. 5 described below, a fallback method in a general RACH-less handover procedure will be described, and in FIG. 6 described below, a fallback method in a conditional RACH-less handover procedure will be described.

FIG. 5 is a sequence chart for describing a RACH-less handover procedure according to an exemplary embodiment of the present disclosure.

Referring to FIG. 5, a terminal 510, a source base station 520 operating a current serving cell (i.e. source cell), a target base station 530 operating a target cell, and an AMF 540 and UPF 550 constituting a core network are illustrated. Hereinafter, the source base station and the target base station may be referred to as a source cell and a target cell, respectively. Alternatively, the source cell and the target cell may be referred to as the source base station and the target base station the operate the respective cells.

The AMF 540 included in the core network previously described in FIG. 1 may provide mobility control information to the source base station 520 (S501).

The terminal 510 that receives measurement configuration information from the source base station 520 may perform measurements according to the measurement configuration information, and transmit measurement results to the source base station 520 through a measurement report (S510).

According to the measurement report received from the terminal 510, the source base station 520 may decide a handover for the terminal 510 (S520).

When the handover for the terminal 510 is decided, the source base station 520 may transmit a handover request message to the target base station 530 (S525). The handover request message may be transmitted through an Xn interface between the source base station 520 and the target base station 530. If the Xn interface between the source base station 520 and the target base station 530 does not exist, the handover request message may be transmitted through an NG interface via the AMF 540. FIG. 5 illustrates a case where the handover request message is delivered through the Xn interface. Procedures described below may be equally applied also when the handover request message is delivered to the target base station 530 through the NG interface via the AMF 540.

The target base station 530 may perform admission control for the requested handover (S530).

When the requested handover is approved, in the target base station 530 may transmit a handover request acknowledge message to the source base station 520 (S535). In this case, the target base station 530 may transmit the handover request acknowledge message by including information on an uplink resource (i.e. information on a UL-grant) for the terminal 510 to perform first UL transmission (e.g. transmission of an RRCReconfigurationComplete message) in the target cell, which is allocated in the pre-configured UL-grant scheme or the dynamic UL-grant scheme described above. In this case, the handover request acknowledge message may additionally include a start time of the UL-grant and an expiration time of the UL-grant. In this case, the expiration time of the UL-grant may be indicated by a setting value for a UL-grant timer, which will be described later. In addition, the handover request acknowledge message may additionally include the maximum number of times the UE transmits the UL message (i.e. RRCReconfigurationComplete message) in the target cell. In addition, the handover request acknowledge message may additionally include information on a dedicated RACH preamble of the target cell for a contention-free random access (CFRA) procedure for recovery of the RACH-less handover, which will be described later.

The source base station 520 may transmit a handover command to the terminal 510 (S540). In this case, the handover command message may be transmitted to the terminal through an RRC reconfiguration message (i.e. RRCReconfiguration message). The RRC reconfiguration message transmitted to the terminal may include information on the UL grant of the target base station previously received through the handover request acknowledge message.

The terminal 510 that receives the handover command from the source base station 520 may start the UL-grant timer at the start time of the UL-grant (S551). In this case, the target base station 530 may also start a corresponding UL-grant timer at the start time of the UL-grant.

Meanwhile, the source base station 520 may deliver buffered data for the terminal to the target base station 530, and perform a procedure for forwarding new data for the terminal 510 transmitted from the UPF 550 to the target base station 530 (S560).

The terminal may transmit a UL message (e.g. RRCReconfigurationComplete) to the target base station 530 in the UL-grant resource of the target base station 530, which is informed through the handover command message (S552). If transmission of the UL message (i.e. RRCReconfigurationComplete) fails, the terminal may repeatedly transmit the UL message (i.e. RRCReconfigurationComplete) up to the maximum number of transmissions set in step S540.

When the maximum number of UL message transmissions is reached or the UL-grant timer expires (S553), the terminal may determine that the RACH-less handover fails and may perform a fallback (or recovery) procedure for the RACH-less handover (S570).

In the fallback procedure for the RACH-less handover, the terminal may select a cell by measuring received signal strengths (e.g. reference signal received power (RSRP), etc.) of the source cell and neighboring cell(s) including the target cell.

If the received signal strength of the target cell 530 is better than the received signal strength of the source cell 520 (i.e. if the received signal strength of the target cell is higher than the received signal strength of the source cell), the terminal may perform a synchronization procedure (i.e. RACH procedure) for the target cell. In this case, the RACH procedure may be a CFRA procedure. The UE may perform the RACH procedure to the target cell by using a dedicated RACH preamble indicated by the handover command message of step S540, and transmit the RRCReconfigurationComplete message, which is an M3 message, to the target base station 530 (S570).

If the received signal strength of the source cell is better than the received signal strength of the target cell (i.e. if the received signal strength of the source cell is higher than the received signal strength of the target cell), the terminal may perform an RRC connection re-establishment procedure for the source cell with the source base station (S570).

FIG. 6 is a sequence chart for describing a RACH-less handover procedure according to another exemplary embodiment of the present disclosure.

Referring to FIG. 6, a terminal 610, a source base station 620 operating a source cell, candidate target base stations 630 and 631 operating candidate target cells, and an AMF 640 and UPF 640 constituting a core network are illustrated. Hereinafter, the source base station and the candidate target base station may be referred to as a source cell and a candidate target cell, respectively. Alternatively, the source cell and the candidate target cell may be referred to as the source base station and the candidate target base station that operate the respective cells. Meanwhile, comparing the procedure illustrated in FIG. 5 with the procedure illustrated in FIG. 6, a difference in the procedure illustrated in FIG. 6 may be that a plurality of candidate target cells can participate in the handover procedure. That is, in the conditional handover, a handover request message may be transmitted from the source base station to each candidate target cell that can become a target cell.

Similarly to the general handover procedure illustrated in FIG. 3, the AMF 640 included in the core network previously described in FIG. 1 may provide mobility control information to the source base station 620 (S601).

The terminal 610 that receives measurement configuration information from the source base station 620 may perform measurements according to the measurement configuration information and transmit measurement results to the source base station 620 through a measurement report (S610).

According to the measurement report received from the terminal 610, the source base station 620 may decide a conditional handover for the terminal 620 (S620).

Unlike the general handover procedure described in FIG. 5, in the conditional handover procedure described in FIG. 6, the source base station may transmit handover request messages to one or more candidate target base stations 630 and 631 that meet handover event conditions (S625, S626). Although FIG. 6 illustrates a case in which two candidate target base stations 630 and 631 exist, the number of candidate target base stations may not be limited to two. The handover request messages may be transmitted through Xn interfaces between the source base station 620 and the candidate target base stations 630 and 631. If there is no Xn interface between the source base station 620 and a specific candidate target base station, the handover request message may be transmitted through an NG interface via the AMF 640. FIG. 6 illustrates a case where the handover request message is delivered through the Xn interface. The procedures described below may be equally applied also when the handover request message is delivered to a specific candidate target base station through the NG interface via the AMF 640.

In response to the handover request message from the source base station 620, each of the candidate target base stations 630 and 631 may perform admission control for the requested handover (S630, S631). Each candidate target base station that approves the requested handover may transmit a handover request acknowledge message to the source base station (S635, S636). In this case, each of the candidate target base stations 630 and 631 may transmit the handover request acknowledge message by including information on an uplink resource (i.e. information on a UL-grant) for the terminal 610 to perform first UL transmission (e.g. transmission of an RRCReconfigurationComplete message) in the corresponding candidate target cell, which is allocated in the pre-configured UL-grant scheme or the dynamic UL-grant scheme described above. In this case, the handover request acknowledge message may additionally include a start time of the UL-grant and an expiration time of the UL-grant. In this case, the expiration time of the UL-grant may be indicated by a setting value for a UL-grant timer, which will be described later. In addition, the handover request acknowledge message may additionally include the maximum number of times the UE transmits the UL message (i.e. RRCReconfigurationComplete message) in the corresponding candidate target cell. In addition, the handover request acknowledge message may additionally include information on a dedicated RACH preamble of the corresponding candidate target cell for a CFRA procedure for recovery of the RACH-less handover, which will be described later.

If at least one candidate target base station approves the requested handover, the source base station 620 may transmit a handover command to the terminal (S640). The handover command may be transmitted through an RRC reconfiguration message (i.e. RRCReconfiguration message). The RRCReconfiguration message transmitted to the terminal may include information on the UL grant of the target base station previously received through the handover request acknowledge message.

The terminal 610 may transmit an RRC reconfiguration complete (i.e. RRCReconfigurationComplete) message to the source base station 620 in response to the RRC reconfiguration message (S650). In the general handover procedure, the RRC reconfiguration complete message is transmitted from the terminal to the target base station after the synchronization procedure (RACH procedure) with the target base station is completed, but in the conditional handover procedure, the RRC reconfigure complete message may be transmitted from the terminal 610 to the source base station (620).

Afterwards, the terminal may evaluate whether at least one candidate target base station meets the conditional handover conditions (CHO conditions) (S670). If a target base station (e.g. target base station 630 in FIG. 6) that meets the CHO condition(s) exists, the source base station 620 may deliver buffered data for the terminal to the target base station 630, and perform a procedure for forwarding new data for the terminal 610 transmitted from the UPF 650 to the target base station 630 (S660).

The terminal may perform first uplink transmission (e.g. transmission of an RRCReconfigurationComplete message) to the target base station 630 in the target cell using the UL-grant resource of the target base station 630, which is informed through the handover command message (S672). If transmission of the UL message (e.g. RRCReconfigurationComplete message) fails, the terminal may repeatedly transmit the UL message (i.e. RRCReconfigurationComplete message) up to the maximum number of UL message transmissions set in step S640.

When the maximum number of UL message transmissions is reached or the UL-grant timer expires, the terminal may determine that the RACH-less handover fails and may perform a fallback (or recovery) procedure for the RACH-less handover.

In the fallback procedure for the RACH-less handover, the terminal may select a cell by measuring received signal strengths (e.g. RSRP, etc.) of the source cell and neighboring cell(s) including the target cell.

If the received signal strength of the target cell 630 is better than the received signal strength of the source cell 620 (i.e. if the received signal strength of the target cell is higher than the received signal strength of the source cell), the terminal may perform a synchronization procedure (i.e. RACH procedure) for the target cell. In this case, the RACH procedure may be a CFRA procedure. The UE may perform a RACH procedure to the target cell by using a dedicated RACH preamble indicated by the handover command message of step S640, and transmit the RRCReconfigurationComplete message, which is an M3 message, to the target base station 630 (S685).

If the received signal strength of the source cell is better than the received signal strength of the target cell (i.e. if the received signal strength of the source cell is higher than the received signal strength of the target cell), the terminal may perform an RRC connection re-establishment procedure for the source cell with the source base station (S685).

### Parameter Configuration for Fallback of RACH-Less Handover

As described above, in the fallback method for RACH-less handover according to the present disclosure, when configuring the UL-grant resource of the target cell to the terminal using the pre-configured UL-grant or dynamic UL-grant scheme, parameters related to the start time of the UL-grant resource and a valid duration (i.e. UL-grant timer) of the UL-grant resource may be configured to the terminal. Additionally, the maximum number of transmissions of the UL message may be set so that the terminal can quickly detect a failure of the RACH-less handover.

The parameters below may be examples of information elements (IEs) that define the UL-grant resource for the RACH-less handover. The parameters below may vary depending on a terrestrial network, non-terrestrial network, or NG-RAN system.

Table 1 shows an example of configuring the start time PreCg-Start-Time of the UL-grant resource and the valid duration PreCg-Timer of the UL-grant resource using PreconfiguredGrantConfig IE, which is additionally configured in the ConfiguredGrantConfig 1E.

TABLE 1

```
PreconfiguredGrantConfig ::= SEQUENCE {
  PreCg-Start-Time PreCgStartTime OPTIONAL,
  PreCg-Timer ENUMERATED{ s5, s10, s15, s20, s25, s30,
s35, s40, s45, s50, s55, s60, s120, s180, s240, s900} OPTIONAL,
  nonCriticalExtension SEQUENCE { } OPTIONAL
{
PreCgStartTime ::= SEQUENCE {
  sfn INTEGER(0..1023),
  subFrame INTEGER(0..9)
}
```

Table 2 shows an example of configuring the start time dynamicULGrant-Start-Time of the UL-grant resource and the valid duration dynamic ULGrant-Timer of the UL-grant resource in the PDCCH-Config IE.

```
TABLE 2
PDCCH-Config ::= SEQUENCE {
  dynamicUlGrant-Start-Time dynamicUlGrantTime OPTIONAL,
  dynamicUlGrant-Timer ENUMERATED{ s5, s10, s15, s20, s25, s30,
s35, s40, s45, s50, s55, s60, s120, s180, s240, s900} OPTIONAL,
}
dynamicUlGrantTime ::= SEQUENCE {
  sfn INTEGER(0..1023),
  subframe INTEGER(0..9)
}
```

Table 3 shows an example of a parameter ulRetxMaxNum indicating the maximum number of UL retransmissions. Since this parameter is used during the RACH-less handover, it may be added in the ReconfigurationWithSync IE.

TABLE 3

```
ReconfigurationWithSync ::= SEQUENCE {
...
  ulRetxMaxNum INTEGER(0..9) OPTIONAL,
  ...
}
```

Therefore, when determining a failure of the RACH-less handover, the terminal may use the maximum number of UL transmissions or the UL-grant timer. That is, the terminal may decide to perform the fallback procedure when the number of UL transmissions reaches the maximum number or when the set UL-grant timer expires. In the fallback procedure, the terminal may perform a RACH procedure using a dedicated RACH preamble for the target cell to transmit the RRCReconfigurationComplete message as in the conventional handover procedure, or the terminal may perform an RRC connection re-establishment procedure with the existing source cell.

In the case of the conditional RACH-less handover, one or more candidate target base stations should reserve UL-grant resources for the handover target terminal. After the handover to the actually selected target base station is successful, other candidate target base stations can reuse the reserved resources. Therefore, if the terminal fails the handover, the UL-grant resources cannot be reused until the terminal reconnects to a specific cell. When many terminals operate in the RACH-less handover manner, a large number of UL-grant resources should be pre-allocated, which may cause significant waste of radio resources across the system. Therefore, as in the exemplary embodiments of the present disclosure, each candidate target base station can maintain the UL-grant resource allocated to the terminal reserved only until the UL-grant timer expires. If the target base station does not receive any uplink transmission from the terminal until the UL-grant timer expires, it can immediately reuse the UL-grant resource. Consequently, using the exemplary embodiments of the present disclosure, the efficient utilization of radio resources can be achieved.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal for a random access channel (RACH)-less handover, the method comprising:
receiving, from a source cell, information on an uplink (UL) grant for UL transmission in a target cell, the information on the UL grant including a start time and an expiration time of the UL grant and/or a maximum number of transmissions according to the UL grant;
performing transmission of a radio resource configuration (RRC) reconfiguration complete message using resources indicated by the UL grant from the start time, until the expiration time or until the transmission is completed up to the maximum number of transmissions from the start time; and
in response to the transmission of the RRC reconfiguration complete message not being successful until the expiration time or until the transmission is completed up to the maximum number of transmissions, performing a fallback procedure for the RACH-less handover.

2. The method according to claim 1, wherein the UL grant is a pre-configured UL grant or dynamic UL grant.

3. The method according to claim 1, wherein the start time of the UL grant is indicated by a system frame number (SFN) and a subframe number.

4. The method according to claim 1, wherein the expiration time of the UL grant is indicated by a setting value for a timer that starts at the start time of the UL grant.

5. The method according to claim 1, wherein the information on the UL grant is transmitted from a target base station operating the target cell to a source base station operating the source cell through a handover request acknowledge message, and is received from the source base station through an RRC reconfiguration message.

6. The method according to claim 1, wherein the fallback procedure for the RACH-less handover comprises:
measuring received signal strengths of the source cell and the target cell;
in response to the received signal strength of the target cell being better than the received signal strength of the source cell, performing a RACH procedure to the target cell; and
transmitting the RRC reconfiguration complete message to the target cell after performing the RACH procedure.

7. The method according to claim 6, wherein the information on the UL grant additionally includes information on a dedicated RACH preamble to be used in the target cell, and the RACH procedure is a contention-free random access (CFRA) procedure using the dedicated RACH preamble.

8. The method according to claim 6, wherein the fallback procedure for the RACH-less handover further comprises: in response to the received signal strength of the source cell being better than the received signal strength of the target cell, performing an RRC connection re-establishment procedure for the source cell.

9. A method of a source base station for a random access channel (RACH)-less handover, the method comprising:
deciding a handover of a terminal based on a measurement report received from the terminal;
transmitting a handover request message requesting the decided handover to a target base station of a target cell determined based on the measurement report received from the terminal;
receiving, from the target base station, information on an uplink (UL) grant for uplink transmission in the target cell, the information on the UL grant including a start time and an expiration time of the UL grant and/or a maximum number of transmissions according to the UL grant;
transmitting the information on the UL grant to the terminal;
attempting reception of a radio resource control (RRC) reconfiguration complete message from the terminal using resources indicated by the UL grant; and
in response to the reception of the RRC reconfiguration complete message not being successful until the expiration time or until transmission of the RRC reconfiguration complete message is completed up to the maximum number of transmissions, performing a fallback procedure for the RACH-less handover with the terminal.

10. The method according to claim 9, wherein the start time of the UL grant is indicated by a system frame number (SFN) and a subframe number.

11. The method according to claim 9, wherein the expiration time of the UL grant is indicated by a setting value for a timer that starts at the start time of the UL grant.

12. The method according to claim 9, wherein the UL grant is a pre-configured UL grant or dynamic UL grant.

13. The method according to claim 9, wherein the information on the UL grant is transmitted from the target base station to the source base station through a handover request acknowledge message, and is transmitted to the terminal through an RRC reconfiguration message.

14. The method according to claim 9, wherein the fallback procedure for the RACH-less handover comprises: in response to the received signal strength of a source cell of the source base station being better than the received signal strength of the target cell, performing an RRC connection re-establishment procedure with the terminal.

15. A method of a target base station for a random access channel (RACH)-less handover, the method comprising:
receiving a handover request message requesting a handover for a terminal from a source base station of a source cell;
transmitting, to the source base station, information on an uplink (UL) grant for uplink transmission in a target cell of the target base station, the information on the UL grant including a start time and an expiration time of the UL grant and/or a maximum number of transmissions according to the UL grant;
attempting reception of a radio resource control (RRC) reconfiguration complete message from the terminal using resources indicated by the UL grant; and
in response to the reception of the RRC reconfiguration complete message not being successful until the expiration time or until transmission of the RRC reconfiguration complete message is completed up to the maximum number of transmissions, performing a fallback procedure for the RACH-less handover with the terminal.

16. The method according to claim 15, wherein the start time of the UL grant is indicated by a system frame number (SFN) and a subframe number.

17. The method according to claim 15, wherein the expiration time of the UL grant is indicated by a setting value for a timer that starts at the start time of the UL grant.

18. The method according to claim 15, wherein the information on the UL grant is transmitted from the target base station to the source base station through a handover request acknowledge message, and is transmitted from the source base station to the terminal through an RRC reconfiguration message.

19. The method according to claim 15, wherein the fallback procedure for the RACH-less handover comprises:
in response to the received signal strength of the target cell being better than the received signal strength of the source cell, performing a RACH procedure with the terminal; and
receiving the RRC reconfiguration complete message from the terminal after performing the RACH procedure.

20. The method according to claim 19, wherein the information on the UL grant additionally includes information on a dedicated RACH preamble to be used in the target cell, and the RACH procedure is a contention-free random access (CFRA) procedure using the dedicated RACH preamble.
